(19) United States
(12) Patent Application Publication
(10) Pub. No.: US 2016/0133353 A1
(43) Pub. Date: May 12, 2016

(54) Multilayer Composite Conductor and Manufacturing Method Thereof

(71) Applicants: Li-Wen Liu, New Taipei City (TW); Wei-Jen Liu, New Taipei City (TW)

(72) Inventors: Li-Wen Liu, New Taipei City (TW); Wei-Jen Liu, New Taipei City (TW)

(21) Appl. No.: 14/534,244

(22) Filed: Nov. 6, 2014

(51) Int. Cl. H01B 5/10; H01B 13/02; H01B 1/02; H01B 3/30; H01B 13/00

(52) U.S. Cl. CPC H01B 5/10; H01B 3/30; H01B 13/0036; H01B 1/023; H01B 1/026; H01B 13/02

(57) ABSTRACT

A multilayer composite conductor comprises an inner layer and an outer layer. The inner layer comprises at least one wire which has a conductivity of 60% to 70% IACS as a core of the multilayer composite conductor; wherein a volume of the inner layer is 40% to 55% of a total volume of the multilayer composite conductor; and the outer layer comprises multiple wires which have a conductivity of 70% to 98% IACS, and the outer layer is wound around the inner layer; wherein a volume of the outer layer is 45% to 60% of the total volume of the multilayer composite conductor. In another aspect, the present invention also provides a method for manufacturing a multilayer composite conductor. At the same current-carrying surface, the multilayer composite conductor of the present invention saves more than 60% of copper usage, thereby achieving light weight and low cost.

### BACKGROUND OF THE INVENTION

1. Field of the Invention

The present invention relates to a multilayer composite conductor for transmitting electric power, particularly, to a multilayer composite conductor that has an inner layer and an outer layer each having a respective specific conductivity to achieve lighter weight and the same current-carrying capacity as compared with conventional copper wires of same gauge.

2. Description of the Prior Arts

Copper has low resistance and high current carrying capacity. Being heavy and rare, copper is mostly used for cables. To make lightweight cables and prolong the availability of the earth's copper resources, the amount of copper inside the cable should be reduced.

In terms of reducing the amount of copper inside the cable, the industry currently has developed copper clad aluminum (CCA) wires and the stranding technology of composite metal wire. However, mono CCA wire as cable cannot sustain twist and will easily break. Although stranding multiple CCA wires can sustain twist, the CCA wires need higher content of copper (more than 20%) to reach the same current-carrying capacity of conventional copper wires. The manufacture of CCA wires is more complicated than conventional copper wires, and the manufacturing cost of the high copper content CCA wires is higher than the ordinary CCA wires. So the manufacturing cost is too high for application on industry.

When the conductor is energized, the current will flow between each of the stranding mono wires. However, corrosion occurs if the oxidations of the outer cover layer of the adjacent two mono wires are different. To avoid corrosion, the solution is using the same metal on the outer cover layer of the adjacent two mono wires. Both U.S. Pat. No. 3,683,103 and EP 2657944 disclose using different materials as the outer cover layer to cover the same metal of the core layer as a core wire. However, these patents do not mention that the different conductivities between the outer layer and the inner layer of the cable will affect the current-carrying capacity.

U.S. Pat. No. 3,683,103 discloses copper and aluminum as mono core wire. When the cable or the wire for electricity transmission is manufactured by this method, the amount of copper is increased or the cross-sectional area of the wire is enlarged to achieve the desired current-carrying capacity. The manufacturing cost is too high for industrial application.

EP 2657944 provides a transmission cable composed exclusively of CCA, the design results in that the conductivity of the outer layer of the cable is lower than the inner layer of the cable because the thickness of copper covering aluminum is in positive correlation to conductivity. So the wire size of the inner layer of the cable must be larger than the wire size of the outer layer of the cable to minimize impact on the current-carrying capacity of the wire in the outer layer, and the CCA needs higher content of copper, which is too expensive to manufacture.

Further, US 20130233586 provides stranding the same CCA as a cable, which uses 30% to 39% copper of CCA as a wire, and compresses the outer layer of the cable to increase the current-carrying capacity. This method also does not consider the different conductivities between the outer layer and the inner layer of the cable will affect the current-carrying capacity, which wastes consumption of copper and increases the weight of the wire. Therefore, the disadvantages in prior arts should be resolved.

### SUMMARY OF THE INVENTION

According to the above description, the present invention provides a multilayer composite conductor, designed on the principle that an outer layer and an inner layer each having a different conductivity will influence the current-carrying capacity of the multilayer composite conductor. Conductivity is frequently expressed in terms of percent IACS (international annealing copper standard). Commercially pure, annealed copper having a resistivity of 0.017241 ohm-mm²/m at 20° C. is regarded as having a conductivity of 100% IACS.

The objective of the invention is to provide a multilayer composite conductor comprising an inner layer and an outer layer. The inner layer comprises at least one wire which has a conductivity of 60% to 70% IACS as a core of the multilayer composite conductor; wherein a volume of the inner layer is 10% to 60% of a total volume of the multilayer composite conductor; and the outer layer comprises multiple wires which have a conductivity of 70% to 98% IACS, and the outer layer is wound around the inner layer; wherein a volume of the outer layer is 40% to 90% of the total volume of the multilayer composite conductor; wherein the at least one wire of the inner layer and the multiple wires of the outer layer are stranded together.

Preferably, the volume of the inner layer is 40% to 55% of the total volume of the multilayer composite conductor, and the volume of the outer layer is 45% to 60% of the total volume of the multilayer composite conductor.

Preferably, the volume of the outer layer is 55% of the total volume of the multilayer composite conductor, and the volume of the inner layer is 45% of the total volume of the multilayer composite conductor.

Preferably, the outer layer further comprises a first sublayer around the inner layer and a second sublayer around the first sublayer, wherein the conductivity of the first sublayer is lower than the conductivity of the second sublayer.

Preferably, the at least one wire of the inner layer and the mulitple wires of the outer layer each comprise a core portion and a cover portion around the core portion.

More preferably, the cover portion comprises copper, copper alloy, silicon, iron, magnesium, rare earth, impurities, or any combination thereof.

More preferably, the core portion comprises aluminum, aluminum alloy, silicon, iron, magnesium, rare earth, impurities, or any combination thereof.

Preferably, the inner layer comprises a wire which has a conductivity of 60% to 70% IACS.

Preferably, the outer layer comprises two groups of wires arranged alternately; wherein one of the groups of wires has a conductivity of 70% to 80% IACS, and the other group of wires has a conductivity of 80% to 98% IACS; wherein a diameter of the wires having a conductivity of 70% to 80% IACS is smaller than a diameter of the wires having a conductivity of 80% to 98% IACS.

Preferably, the multilayer composite conductor further comprises a middle layer located between the inner layer and the outer layer, wherein the middle layer comprises multiple wires and the conductivity of the wires of the middle layer is not lower than the conductivity of the inner layer and not higher than the conductivity of the outer layer.

More preferably, the outer layer further comprises a first sublayer and a second sublayer, wherein the first sublayer and the second sublayer respectively comprise multiple wires; wherein the first sublayer is around the inner layer or the middle layer, and the second sublayer is around the first sublayer; wherein the conductivity of the first sublayer is lower than the conductivity of the second sublayer.

Preferably, the multilayer composite conductor further comprises a plastic wire wound around by the inner layer.

Preferably, the plastic wire is a high tensile wire, which includes, but is not limited to, nylon, polypropylene, polyethylene or any combination thereof.

In one another aspect, the present invention also provides a method for manufacturing a multilayer composite conductor, the method comprising the steps of: (1) using the at least one wire of the inner layer as a core wire; (2) winding the outer layer around the inner layer; and (3) stranding the inner layer and the outer layer together through a stranding machine to obtain the multilayer composite conductor.

Preferably, the step (1) further comprises the steps of: using a plastic wire as a core composite conductor; sustaining the plastic wire in the center of the multilayer composite conductor; and winding the inner layer around the plastic wire.

More preferably, the step of winding the inner layer around the plastic wire further comprises the steps of winding the middle layer around the inner layer.

Preferably, the outer layer comprises two groups of wires arranged alternately; wherein one of the groups of wires has a conductivity of 70% to 80% IACS, and the other group of wires has a conductivity of 80% to 98% IACS; wherein a diameter of the wires having a conductivity of 70% to 80% IACS is smaller than a diameter of the wires having a conductivity of 80% to 98% IACS.

The advantages of the present invention are:

1. On the same current-carrying surface, the multilayer composite conductor of the present invention saves more than 60% of the copper usage compared with conventional copper wires, and the current-carrying capacity is the same as the conventional copper wires, so light weight and low cost of the present invention are both achieved.

2. When the volume of the outer layer occupies more than 55% of the total volume of the multilayer composite conductor, the current-carrying capacity and the temperature rise at the same current of the multilayer composite conductor of the present invention is the same as the pure copper conductor.

Other objectives, advantages and novel features of the invention will become more apparent from the following detailed description when taken in conjunction with the accompanying drawings.

### BRIEF DESCRIPTION OF THE DRAWINGS

FIG. 1 is a curve diagram showing the temperature rise at the same current at different volumes of the inner layer;

FIG. 2 shows the temperature rise at the same current affected by the inner layer that occupies 60% volume of the composite conductor;

FIG. 3 shows the temperature rise at the same current affected by the outer layer that occupies 40% volume of the composite conductor;

FIG. 4 is the perspective view of the wire A of the present invention having 60% to 70% IACS;

FIG. 5 is the perspective view of the wire B of the present invention having 70% to 80% IACS;

FIG. 6 is the perspective view of the wire C of the present invention having 80% to 98% IACS;

FIG. 7 is a flow chart illustrating the method for manufacturing a multilayer composite conductor of the present invention;

FIG. 8 is the cross-sectional view of Example 1 of the present invention;

FIG. 9 is the cross-sectional view of Example 2 of the present invention;

FIG. 10 is the cross-sectional view of Example 3 of the present invention;

FIG. 11 illustrates the temperature rises of commercially available products and Examples 1-3 of the present invention under normal loading and high loading, wherein “normal loading” means the safety current load for each size of flexible cord at 30° C. as established by Underwriters Laboratories Inc. (UL); “high loading” means the safety current load for each size of flexible cord at 60° C. as established by National Electrical Code (NEC).

### DETAILED DESCRIPTION OF THE PREFERRED EMBODIMENTS

### PREPARATION EXAMPLE 1

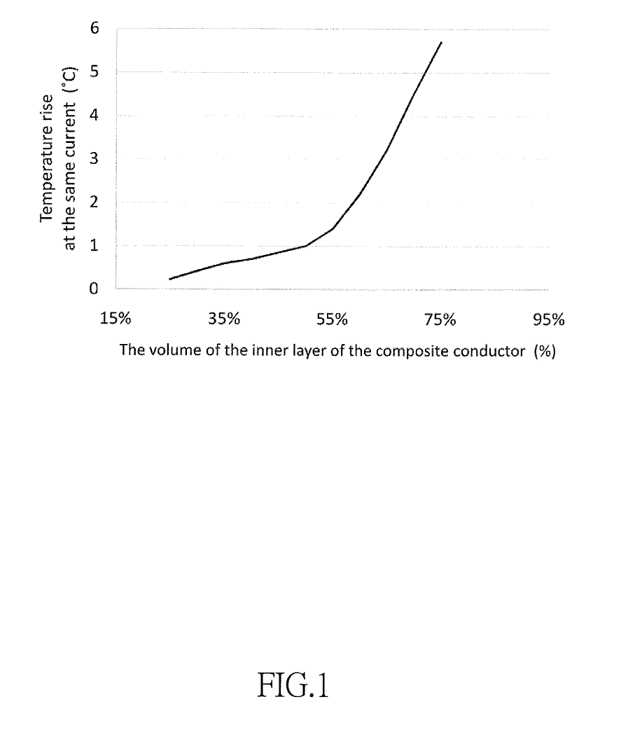

Different volumes of 60% IACS composite metal wires were used on an inner layer of the multilayer composite conductor, and copper wires were used on an outer layer of the multilayer composite conductor. The temperature rise is within 1° C., representing that the multilayer composite conductor complies with the current safety regulation. FIG. 1 show that when the volume of the inner layer was around 40% to 55% of the total volume of the multilayer composite conductor, the temperature rise was within 1° C. Further, the outer layer occupying 45% to 60% of the volume of the multilayer composite conductor affected the current-carrying capacity more than the inner layer occupying 40% to 55% of the volume of multilayer composite conductor, thereby satisfying both current-carrying capacity and economical concerns.

### PREPARATION EXAMPLE 2

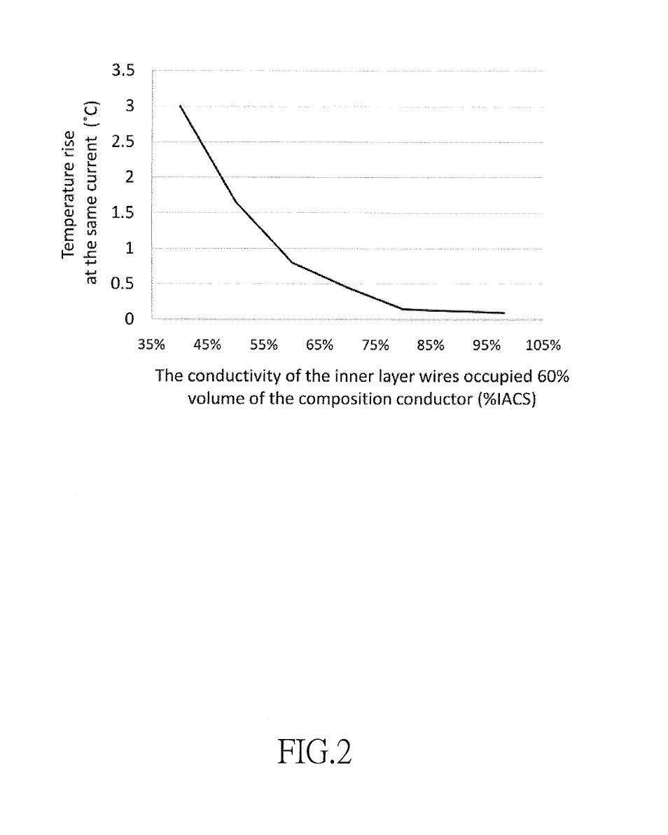

Composite metal wires of different % IACS were used on an inner layer of the multilayer composite conductor, and copper wires were used on an outer layer of the multilayer composite conductor. FIG. 2 shows that the conductivity of the inner layer of the multilayer composite conductor reached above 60% IACS, and the inner layer of the multilayer composite conductor decreased the effect on the current-carrying capacity to the multilayer composite conductor.

### PREPARATION EXAMPLE 3

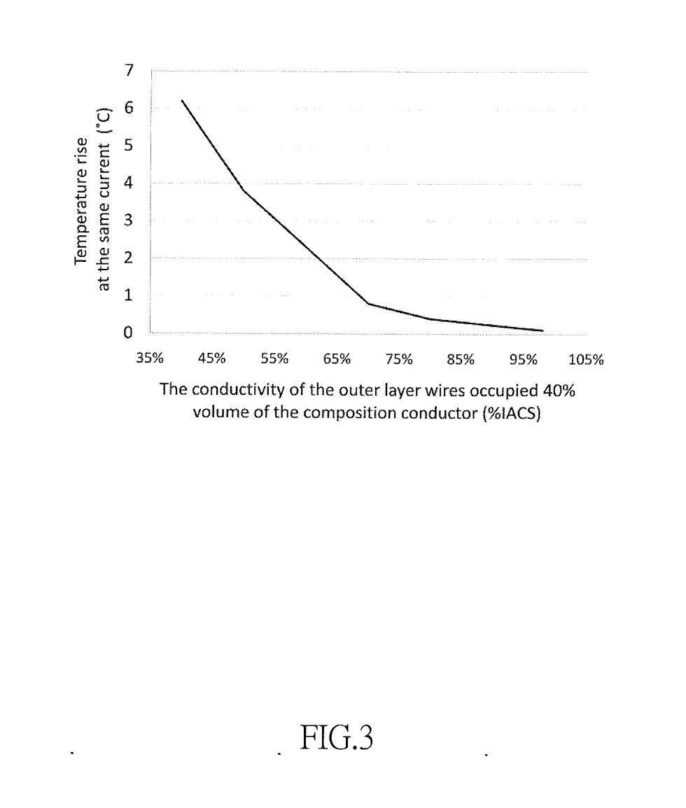

Composite metal wires of different percentages of IACS were used on the outer layer of the multilayer composite conductor, and 60% IACS composite metal wires were used on the inner layer of the multilayer composite conductor. As shown in FIG. 3, when the conductivity reached above 70% IACS, the outer layer of the multilayer composite conductor decreased the effect on the current-carrying capacity to the multilayer composite conductor.

### PREPARATION EXAMPLE 4

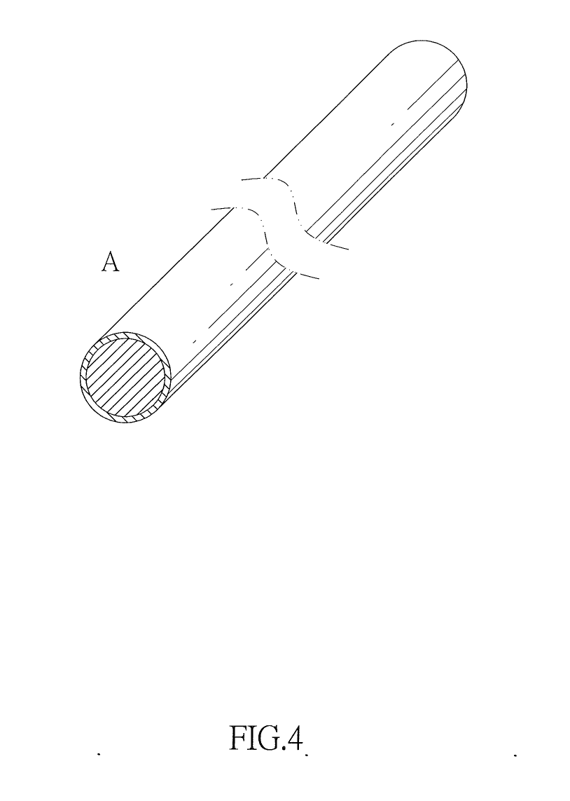

As shown in FIG. 4 to 6, the wire A, wire B and wire C were composite metal wires, the composite metal wires each respectively comprised a core portion and a cover portion covering the core portion. The core portion included, but was not limited to, aluminum, aluminum alloy, silicon, iron, magnesium, rare earth, impurities, or any combination thereof. The cover portion comprised copper, copper alloy, silicon, iron, magnesium, rare earth, impurities, or any combination thereof. In the preferred embodiment, the wire A comprised 8% copper, the wire B comprised 40% copper and the wire C comprised 80% copper. Adjusting content of copper is one of the ways to achieve different conductivities, and rare earth, impurities, or any other materials can be added to achieve desired conductivity. Moreover, the conductivity of the wire A was 60% to 70% IACS, the conductivity of the wire B was 70% to 80% IACS, and the conductivity of the wire C was 80% to 98% IACS.

### PREPARATION EXAMPLE 5

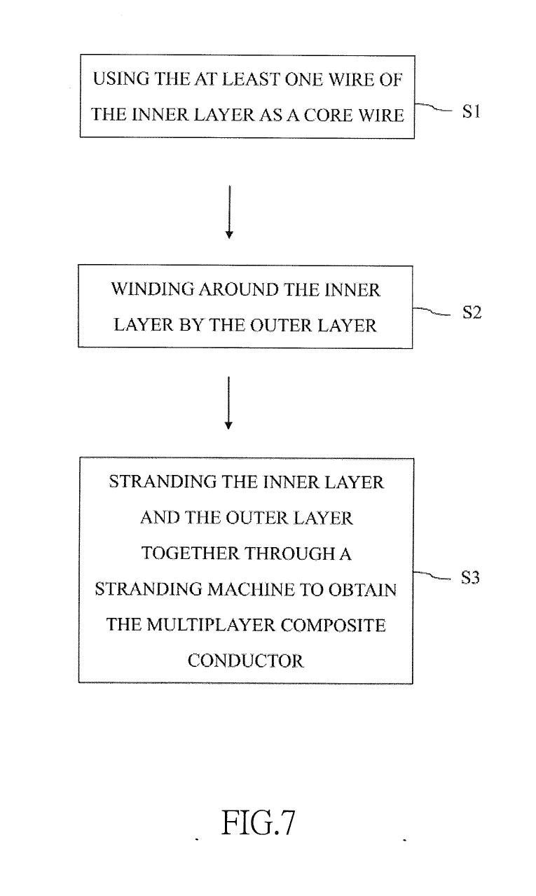

As shown in FIG. 7, the present invention also provides a method for manufacturing a multilayer composite conductor, and comprises the following steps: using at least one wire of the inner layer as a core wire (S1); winding the outer layer around the inner layer (S2); and, stranding the inner layer and the outer layer together through a stranding machine to obtain the multilayer composite conductor (S3).

### PREPARATION EXAMPLE 6

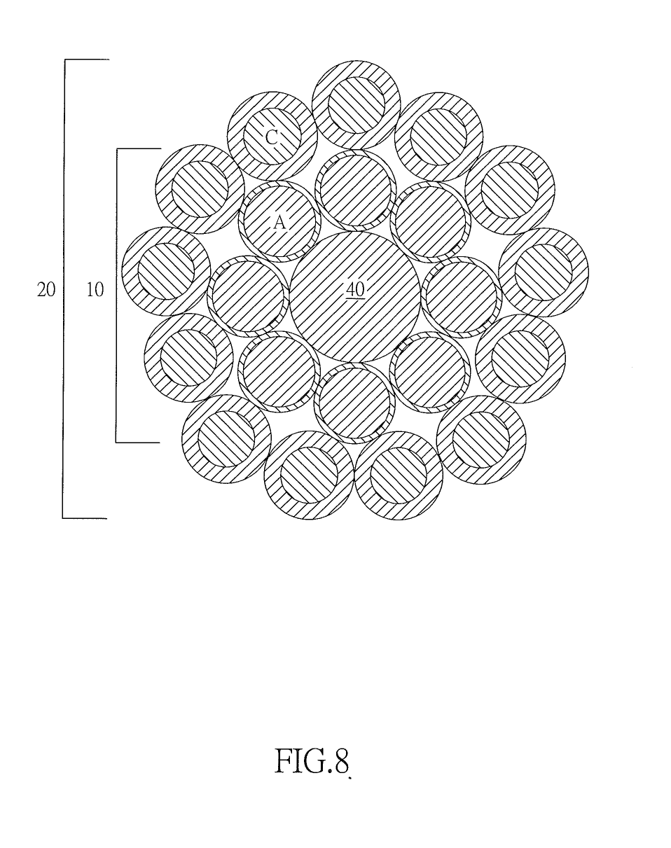

According to the method of the preparation example 5, a multilayer composite conductor 1 comprising an inner layer 10 and an outer layer 20 as shown in FIG. 8 was obtained. The inner layer 10 comprised at least one wire which had a conductivity of 60% to 70% IACS as a core multilayer composite conductor; the volume of the inner layer 10 ranged from 10% to 60%, preferably 40% to 55%, more preferably 45%, of the total volume of the multilayer composite conductor 1. The outer layer 20 comprised multiple wires which had a conductivity of 70% to 98% IACS, and the outer layer 20 was wound around the inner layer 10; the volume of the outer layer 20 ranged from 40% to 90%, preferably 45% to 60%, more preferably 55%, of the total volume of the multilayer composite conductor 1; wherein the at least one wire of the inner layer 10 and the multiple wires of the outer layer 20 were stranded together.

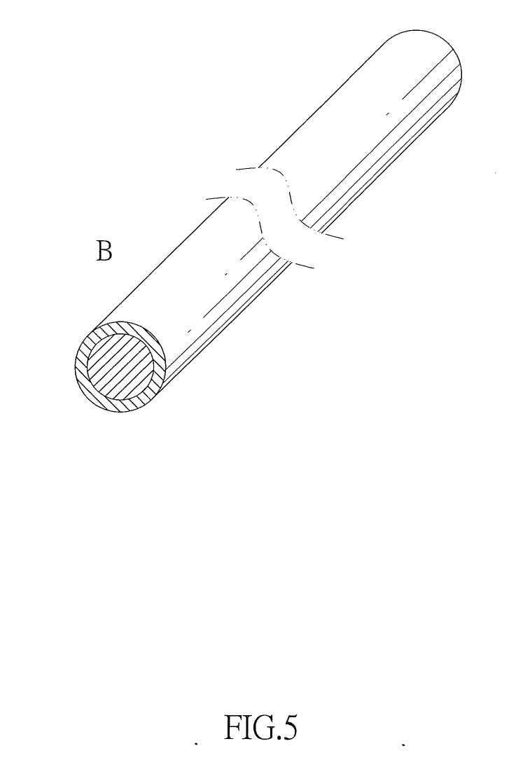

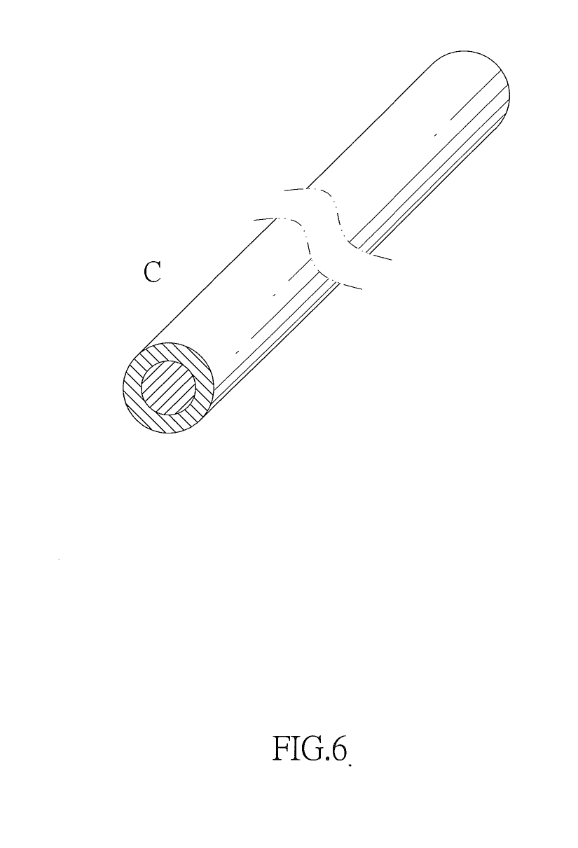

In the preferred embodiment, the inner layer 10 was composed of a wire A which had a conductivity of 60% to 70% IACS as shown in FIG. 4. In the preferred embodiment, as shown in FIGS. 5 to 6, the outer layer 20 was composed of wires B and wires C, and the wires B and the wires C were arranged alternately; wherein the wires B had a conductivity of 70% to 80% IACS, and the wires C had a conductivity of 80% to 98% IACS; wherein a diameter of wire B was smaller than a diameter of the wire C.

In the preferred embodiment, the multilayer composite conductor 1 further comprised a plastic wire 40 wound around by the inner layer 10. The plastic wire 40 was a high tensile wire, which included, but was not limited to, nylon, polypropylene, polyethylene and any combination thereof. The purpose of the plastic wire 40 in the core of the multilayer composite conductor 1 of the present invention was to separate the bending or stretching force when the multilayer composite conductor 1 was subjected to the above-mentioned force.

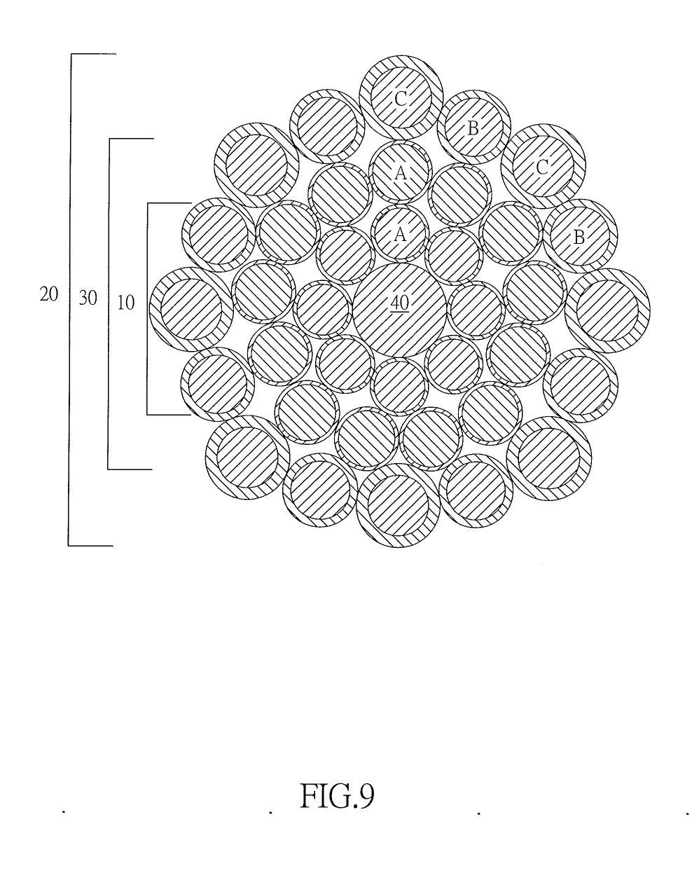

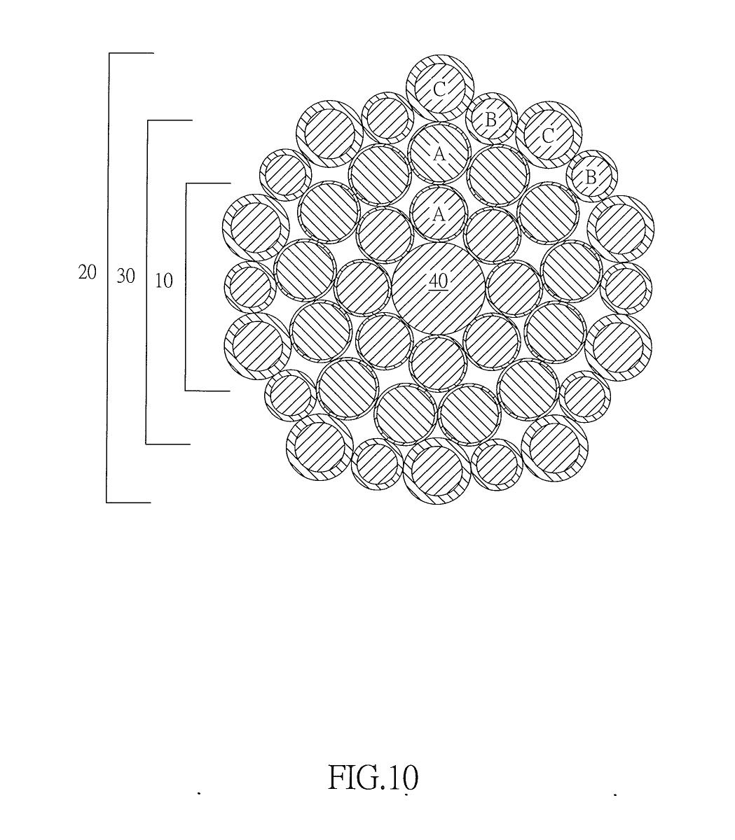

As shown in FIGS. 9 and 10, the multilayer composite conductor 1 further comprised a middle layer 30 located between the inner layer 10 and the outer layer 20, wherein the middle layer 30 comprised multiple wires and the conductivity of the wires of the middle layer 30 was not lower than the conductivity of the inner layer 10 and not higher than the conductivity of the outer layer 20.

To obtain the thicker multilayer composite conductor 1, the outer layer 20 further comprised a first sublayer and a second sublayer, wherein the first and the second sublayers respectively comprised multiple wires; wherein the first sublayer was around the inner layer 10 or the middle layer 30, and the second sublayer was around the first sublayer; wherein the conductivity of the first sublayer was lower than the conductivity of the second sublayer. The volume of the outer layer 20 ranged from 40% to 90%, preferably 45% to 60%, more preferably 55%, of the total volume of the multilayer composite conductor 1. To obtain thicker multilayer composite conductor 1, the outer layer 20 can further comprise more than two sublayers based on the above principle.

### EXAMPLE 1

### The Same Diameters and Current-Carrying Capacity as American Wire Gauge Number 22 (AWG #22)

According to the method of the preparation example 5 and FIG. 8, a plastic wire 40 was used as a core composite conductor; the plastic wire 40 was wound around by eight wires A as the inner layer 10 of the multilayer composite conductor 1, the diameter of each wire A was 0.15 mm (millimeter); the inner layer 10 was wound around by thirteen wires C as the outer layer 20 of the multilayer composite conductor 1, the diameter of each wire C was 0.13 mm; the plastic wire 40, the inner layer 10 and the outer layer 20 were stranded together through a stranding machine, then the multilayer composite conductor 1 was obtained.

### EXAMPLE 2

### The Same Diameters and Current-Carrying Capacity as AWG #18

As shown in FIGS. 7 and 9, a plastic wire 40 was used as a core composite conductor; the plastic wire 40 was wound around by eight wires A as the inner layer 10 of the multilayer composite conductor 1, the diameter of each wire A was 0.15 mm; the inner layer 10 was wound around by thirteen wires A as the middle layer 30 of the multilayer composite conductor 1, the diameter of each wire A was 0.15 mm, wherein the conductivity of the middle layer 30 was not lower than the conductivity of the inner layer 10 and not higher than the conductivity of the outer layer 20; the middle layer 30 was wound around by eight wires B and eight wires C as the outer layer 20 of the multilayer composite conductor 1, the wires B and the wires C were arranged alternately, and the diameter of each wire B was 0.18 mm and the diameter of each wire C was 0.2 mm; the plastic wire 40, the inner layer 10, the middle layer 30 and the outer layer 20 were stranded together through a stranding machine, then the multilayer composite conductor 1 was obtained.

### EXAMPLE 3

### The Same Diameters and Current-Carrying Capacity as AWG #16

As shown in FIGS. 7 and 10, a plastic wire 40 was used as a core composite conductor; the plastic wire 40 was wound around by eight wires A as the inner layer 10 of the multilayer composite conductor 1, the diameter of each wire A was 0.2 mm; the inner layer 10 was wound around by thirteen wires A as the middle layer 30 of the multilayer composite conductor 1, the diameter of each wire A was 0.2 mm, wherein the conductivity of the middle layer 30 was not lower than the conductivity of the inner layer 10 and not higher than the conductivity of the outer layer 20; the middle layer 30 was wound around by ten wires B and ten wires C as the outer layer 20 of the multilayer composite conductor 1, the wires B and the wires C were arranged alternately, and the diameter of each wire B was 0.20 mm and the diameter of each wire C was 0.254 mm; the plastic wire 40, the inner layer 10, the middle layer 30 and the outer layer 20 were stranded together through a stranding machine to obtain the multilayer composite conductor 1.

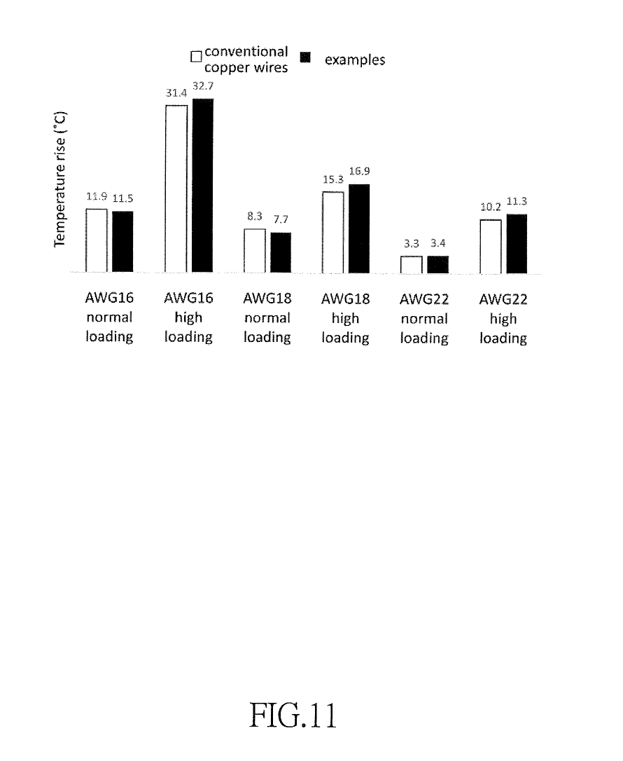

As shown in FIG. 11, with regards to the normal loading, the temperature rises of AWG #16, AWG #18 and AWG #22 of both conventional copper wires and the multilayer composite conductors obtained from the above examples of the present invention were nearly the same. With regards to the high loading, the temperature rises of AWG #16, AWG #18 and AWG #22 of both commercially available products and examples of the present invention were also nearly the same. Therefore, the present invention provided the composite wires of at least two different conductivities for stranding to a multilayer composite conductor 1. For the objective of light weight, the core of the composite wire was aluminum or aluminum alloy. The outer layer 20 of the multilayer composite conductor 1 had the highest content of copper and the highest conductivity, the inner layer 10 of the multilayer composite conductor 1 had the lowest content of copper and the lowest conductivity, and the content of copper and conductivity of the middle layer 30 of the multilayer composite conductor 1 were between those of both the outer layer 20 and the inner layer 10 of the multilayer composite conductor 1. Multiple layers of composite wires were stranded together. The experiment demonstrated that when the volume of the outer layer 20 occupied more than 55% of the total volume of the multilayer composite conductor 1, the current conductivity of the multilayer composite conductor 1 was the same as the overall copper stranding wire.

The tensile strength and strand resistance were weak when aluminum was used as the main metal of composite wires, which was not suitable for the low current-carrying capacity wire that requires frequently bending the wire. The tensile strength of the multilayer composite conductor 1 with plastic wires 40 inside was 1.1 fold stronger than the multilayer composite conductor 1 stranded by the pure copper, and the strand resistances were the same.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multilayer composite conductor, comprising:
an inner layer comprising at least one wire which has a conductivity of 60% to 70% IACS (international annealing copper standard) as a core of the multilayer composite conductor; wherein a volume of the inner layer is 10% to 60% of a total volume of the multilayer composite conductor; and
an outer layer comprising multiple wires which have a conductivity of 70% to 98% IACS, wherein the outer layer is wound around the inner layer and a volume of the outer layer is 40% to 90% of the total volume of the multilayer composite conductor;
wherein the at least one wire of the inner layer and the multiple wires of the outer layer are stranded together.

2. The multilayer composite conductor according to claim 1, wherein the volume of the inner layer is 40% to 55% of the total volume of the multilayer composite conductor, and the volume of the outer layer is 45% to 60% of the total volume of the multilayer composite conductor.

3. The multilayer composite conductor according to claim 1, wherein the outer layer further comprises a first sublayer around the inner layer and a second sublayer around the first sublayer, wherein the conductivity of the first sublayer is lower than the conductivity of the second sublayer.

4. The multilayer composite conductor according to claim 1, wherein the at least one wire of the inner layer and the multiple wires of the outer layer each comprise a core portion and a cover portion around the core portion.

5. The multilayer composite conductor according to claim 4, wherein the cover portion comprises copper, copper alloy, silicon, iron, magnesium, rare earth, impurities, or any combination thereof.

6. The multilayer composite conductor according to claim 4, wherein the core portion comprises aluminum, aluminum alloy, silicon, iron, magnesium, rare earth, impurities, or any combination thereof.

7. The multilayer composite conductor according to claim 1, wherein the inner layer comprises a wire which has a conductivity of 60% to 70% IACS.

8. The multilayer composite conductor according to claim 1, wherein the outer layer comprises two groups of wires arranged alternately; wherein one of the groups of wires has a conductivity of 70% to 80% IACS, and the other group of wires has a conductivity of 80% to 98% IACS; wherein a diameter of the wires having a conductivity of 70% to 80% IACS is smaller than a diameter of the wires having a conductivity of 80% to 98% IACS.

9. The multilayer composite conductor according to claim 1, wherein the multilayer composite conductor further comprises a middle layer located between the inner layer and the outer layer, and the middle layer comprises multiple wires and the conductivity of the wires of the middle layer is not lower than the conductivity of the inner layer and not higher than the conductivity of the outer layer.

10. The multilayer composite conductor according to claim 9, wherein the outer layer further comprises a first sublayer and a second sublayer, wherein the first sublayer and the second sublayer respectively comprise multiple wires; wherein the first sublayer is around the inner layer or the middle layer, and the second sublayer is around the first sublayer; wherein the conductivity of the first sublayer is lower than the conductivity of the second sublayer.

11. The multilayer composite conductor according to claim 1, wherein the multilayer composite conductor further comprises a plastic wire, and the inner layer is wound around the plastic wire.

12. The multilayer composite conductor according to claim 1, wherein the plastic wire is a high tensile wire, and the material of the plastic wire is nylon, polypropylene, polyethylene or any combination thereof.

13. A method for manufacturing a multilayer composite conductor as claimed in claim 1, the method comprising the steps of:
(1) using the at least one wire of the inner layer as a core wire;
(2) winding the outer layer around the inner layer; and
(3) stranding the inner layer and the outer layer together through a stranding machine to obtain the multilayer composite conductor.

14. The method for manufacturing the multilayer composite conductor according to claim 13, wherein the step (1) further comprises the steps of:
using a plastic wire as a core composite conductor;
sustaining the plastic wire in the center of the multilayer composite conductor; and,
winding the inner layer around the plastic wire.

15. The method for manufacturing the multilayer composite conductor according to claim 14, wherein the step of winding the inner layer around the plastic wire further comprises the steps of:
winding the middle layer around the inner layer.

16. The method for manufacturing the multilayer composite conductor according to claim 13, wherein the outer layer comprises two groups of wires arranged alternately; wherein one of the groups of wires has a conductivity of 70% to 80% IACS, and the other group of wires has a conductivity of 80% to 98% IACS; wherein a diameter of the wires having a conductivity of 70% to 80% IACS is smaller than a diameter of the wires having a conductivity of 80% to 98% IACS.
